(19) United States
(12) Patent Application Publication
(10) Pub. No.: US 2008/0229928 A1
(43) Pub. Date: Sep. 25, 2008

(54) SORPTION PUMP WITH INTEGRATED THERMAL SWITCH

(76) Inventors: John A. Urbahn, Saratoga Springs, NY (US); Jan Ardenkjaer-Larsen, Frederiksberg C (DK)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/688,668

(22) Filed: Mar. 20, 2007

(51) Int. Cl. B01D 53/02

(52) U.S. Cl. 96/146

(57) ABSTRACT

A sorption pumping system includes a conductive inner vessel having a sorbent material therein to adsorb gas molecules. An outer vessel is positioned about the inner vessel and includes a heat transfer flange connected thereto. A gas chamber is formed between the inner vessel and the outer vessel. The gas chamber is constructed to sealably contain a thermally conductive gas therein.

### BACKGROUND OF THE INVENTION

The present invention relates generally to a sorption pump, and, more particularly, to a sorption pump with an integrated thermal switch.

Sorption pumps are vacuum pumps that create a partial vacuum in a desired system by adsorbing molecules on a very porous molecular sieve material (i.e., sorbent material) that is cooled to a cryogenic temperature. Sorption pumps allow for pressure in a system to be lowered to about 10⁻⁷ mbar without many of the disadvantages associated with other types of pumping systems used to lower pressure. That is, sorption pumps provide the advantages of eliminating oil and other contaminants present in open system pumps and of providing low cost and vibration free operation because of the absence of moving parts therein.

A sorption pump is usually constructed as a stainless steel, aluminum, or borosilicate glass container that is filled with a sorbent material such as a synthetic zeolite or activated charcoal. The sorption pump is fluidly connected to a desired system by way of tubing and/or valves to allow for the transferring of molecules therebetween. Also present is a mechanism or means for cooling the sorption pump to a cryogenic temperature to allow for adsorption of molecules in the sorbent material. One way to lower the temperature of the sorbent material to a cryogenic temperature is by immersing it in a Dewar flask (i.e., vacuum flask) filled with liquid nitrogen. However, the cooling provided by liquid nitrogen is not always sufficient for adsorbing certain molecules. One example of this is when the system connected to the sorption pump (from which molecules are to be adsorbed) contains a liquid helium bath. Helium molecules do not sufficiently adsorb at liquid nitrogen temperatures, and as such, a better suited cooling mechanism that can produce lower temperatures is needed for such a system.

Another mechanism for cooling the sorbent material to a cryogenic temperature, and which is more suited to systems in which a sorption pump must adsorb helium molecules, is a closed cycle refrigerator. In such a configuration, the sorption pump is thermally connected to the refrigerator by way of, for example, a thermal buss. The thermal buss places the sorption pump in thermal contact with the refrigerator to cool the sorbent material to a suitably low cryogenic temperature. Regardless of the exact mechanism for cooling the sorbent material, it is necessary to alternate the cooling of the sorption pump with periods of re-heating the pump to a higher temperature (i.e., such as room temperature). That is, in order to operate efficiently, the sorption pump must be operated in a cyclical fashion. In one mode or phase, the pump operates in sorption mode where the sorbent material is cooled to a cryogenic temperature to adsorb molecules. In a desorption mode or phase (and optionally a regeneration phase), the sorbent material is allowed to warm up to room temperature to allow the molecules to escape therefrom.

As the sorbent material must be placed in alternating states of cooling and re-heating, it is necessary to provide a mechanism for switching the sorption pump into and out of thermal contact with the cooling source. In a configuration where the sorption pump is connected to a closed cycle refrigerator and thermal buss for cooling, a thermal switch is employed to selectively connect the refrigeration system to the sorption pump. In existing pump designs, this thermal switch is positioned externally from the sorption pump. This externally located thermal switch adds to the complexity of an overall system by adding an additional component thereto. The addition of a separate thermal switch component adds to the cost of the overall system and provides greater opportunity for electrical or mechanical malfunction. Additionally, the placement of the thermal switch external from the sorption pump increases the overall heat transfer path length between the refrigerator and the sorption pump, thus reducing overall thermal performance and adding still further costs for cooling the pump.

Thus, current thermal switches used to activate and deactivate a sorption pump to switch between sorption and desorption modes are inefficient and result in higher costs and a greater probability of malfunction. A need therefore exists for a sorption pump that can integrate the function of the thermal switch therein to minimize cost and inefficiencies associated with a separate, external thermal switch.

### BRIEF DESCRIPTION OF THE INVENTION

The present invention provides a sorption pumping apparatus with an integrated thermal switch that overcomes the aforementioned drawbacks. A gas chamber formed in a sorption pump acts as a thermal switch that selectively places the sorption pump in sorption and desorption modes.

According to one aspect of the present invention, a sorption pumping system includes an inner vessel having a sorbent material to adsorb gas molecules therein and an outer vessel positioned about the inner vessel. The sorption pumping system also includes a heat transfer flange connected to the outer vessel and a gas chamber formed between the inner vessel and the outer vessel, the gas chamber being constructed to sealably contain a thermally conductive gas therein.

In accordance with another aspect of the present invention, an apparatus to lower pressure of a gas in an external system includes a thermally conductive inner vessel, a sorbent material contained in the inner vessel, and an outer vessel surrounding the inner vessel in a separated relation to form a vacuum sealed chamber therebetween. The apparatus also includes a conductive flange thermally connected to the outer vessel, wherein the vacuum sealed chamber is configured to selectively place the sorbent material and the conductive flange in thermal contact.

In accordance with yet another aspect of the present invention, a method for constructing a sorption pumping system includes the steps of filling a conductive inner vessel with a sorbent material and enclosing the inner vessel with an outer vessel, wherein an intermediate gas gap is formed between the inner vessel and the outer vessel. The method also includes the steps of positioning a conductive flange on the outer vessel, that is thermally connected thereto and fluidly connecting a gas line to the intermediate gas gap to add and remove a conductive gas therefrom to selectively place the conductive flange and the sorbent material in thermal contact with one another.

Various other features and advantages of the present invention will be made apparent from the following detailed description and the drawings.

### BRIEF DESCRIPTION OF THE DRAWINGS

The drawings illustrate an embodiment presently contemplated for carrying out the invention.

In the drawings:

FIG. 1 is a block diagram and schematic of a sorption pumping system according to an embodiment of the current invention.

FIG. 2 is a cross-sectional view of an apparatus to lower pressure in an external system according to an embodiment of the current invention.

### DETAILED DESCRIPTION OF THE INVENTION

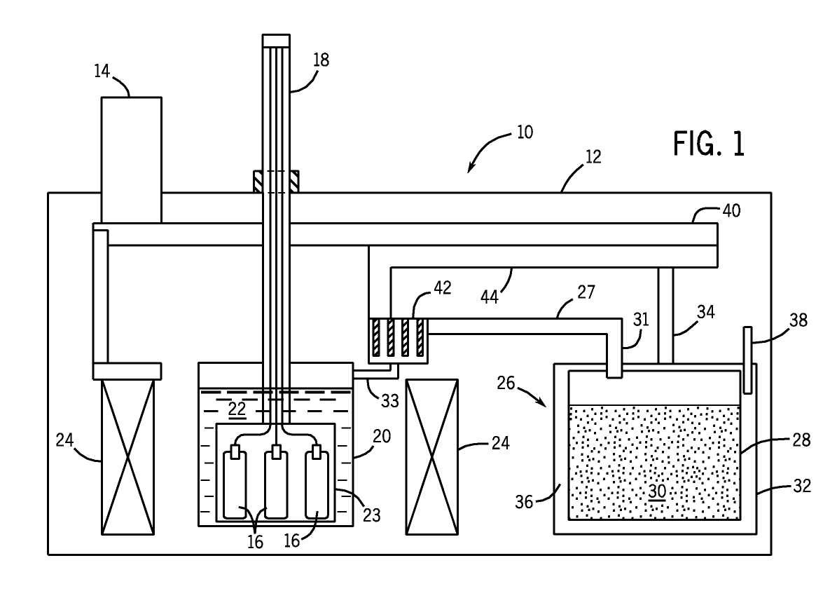

Referring to FIG. 1, an embodiment of sorption pumping system 10 is shown. The sorption pumping system 10 is a closed cyclical thermal system configured to hyperpolarize a sample of an imaging agent for use in MRI. For example, the sample can be composed of ¹³C₁-Pyruvate or another similar metabolic imaging agent that can be polarized. Sorption pumping system 10 is formed in part by a vacuum chamber 12 that surrounds the internal components of the system. A refrigerator 14 that functions as a cooling system for the system is also included. In one embodiment, refrigerator is a closed cycle refrigerator capable of providing low temperature environments below 10 K. As shown in FIG. 1, the refrigerator 14 is positioned, at least in part, externally from vacuum chamber 12. Such a configuration allows any heat generated by the refrigerator 14 to be exhausted in the ambient environment rather than into the exterior of vacuum chamber 12.

The substance or material to be polarized (e.g., ¹³C₁-Pyruvate), hereafter referred to as sample 16, is positioned within vacuum chamber 12 for hyperpolarization. The sample 16 is attached to a mechanism for adding and removing the sample to the sorption pumping system 10. As shown in FIG. 1, sample 16 is placed within sorption pumping system 10 via a sample-introducing means such as a removable sample-transporting tube 18. Sample-transporting tube 18 can be sealed at its upper end in any suitable way in order to retain the partial vacuum in container 20, in which sample 16 is placed. While tube 18 has been described as the mechanism for introducing sample in the embodiment shown in FIG. 1, other mechanisms well known in the art may also be used that allow for the sample to be placed in and removed from sorption pumping system 10.

To allow for hyperpolarization of the sample 16, the sample is placed in container 20 having a cryogenic refrigerant 22 therein, which typically is in the form of a liquid helium bath 22. Preferably, the sample 16 is positioned in a holding container 23 that is in thermal contact with liquid helium bath 22 of container 20. This placement of sample 16 into holding container 23 increases the longevity of the sorption pumping system 10 and improves system efficiency, as the sample loading inevitably introduces contamination into the sorption pumping system 10, and more particularly, to a sorption pump 26 in the system. The sorption pump 26 is sensitive to contamination and cannot easily be restored, and thus, placement of sample 16 in the holding container 23 helps to prevent these contaminants from entering into liquid helium bath 22. Container 20 is sealable and can be evacuated to low pressures (e.g. pressures of the order of 1 mbar or less) as will be explained in greater detail below. To allow for hyperpolarization of the sample 16, the temperature of liquid helium bath 22 is lowered to a suitable temperature, e.g. temperatures below 4.2 K and preferably below 1.5 K.

Positioned about container 20 and the liquid helium bath 22 is magnetic field producing device 24. In the embodiment of FIG. 1, magnetic field producing device 24 is a superconducting magnet having a bore therethrough in which container 20 is placed. Superconducting magnet 24 is capable of creating a magnetic field strength that is sufficiently high, e.g. between 1-25 T or more, for example 3.5 T, for hyperpolarization of the sample 16 to take place. To ensure efficient operation of superconducting magnet 24, the magnet is cooled by way of refrigerator 12.

As mentioned above, container 20 is sealable and can be evacuated to low pressures. Evacuation of container 20 to a low pressure in turn reduces the temperature of liquid helium bath 22 by vaporizing a portion of liquid helium and moving the state point down the helium saturation curve. That is, the boiling temperature of liquid helium (4.2 K) is a function of its vapor pressure. By reducing the pressure on the liquid helium bath 22, it is possible to cool it, and the sample 16 therein, to about 1 K without any further complications. This low temperature then allows for transformation of the sample 16 to a high fractional polarization state that is desired.

To achieve this reduction in pressure on liquid helium bath 22, an apparatus to lower pressure 26 (i.e., a sorption pump) is fluidly connected to container 20 by way of a pumping line 27. Sorption pump 26 is configured to lower pressure in container 20 by adsorbing molecules from liquid helium bath 22. Sorption pump 26 operates in this sorption mode (i.e., polarization/pumping phase) when the pump is lowered to a cryogenic temperature. That is, when sorption pump is cooled to a temperature of ˜10 K or below, helium gas will evaporate from liquid helium bath 22 and be adsorbed by sorption pump 26 forming a monolayer or two on a sorbent material therein.

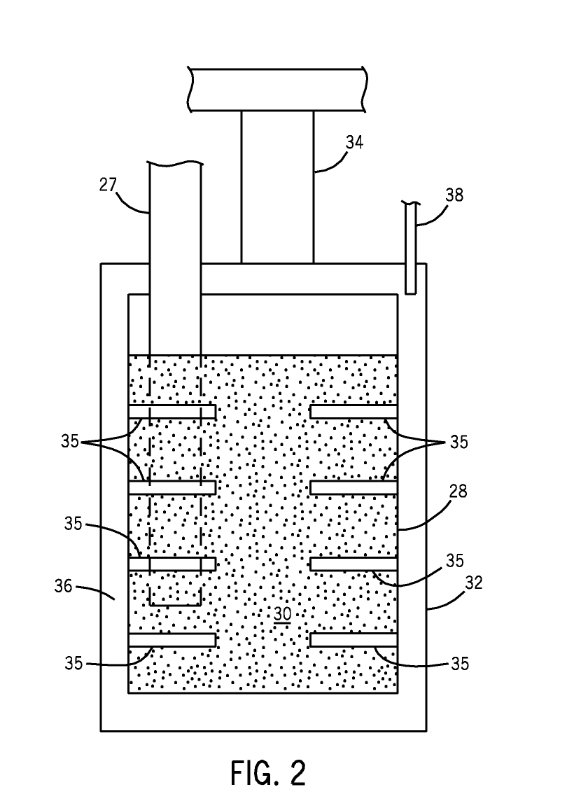

An embodiment of sorption pump 26 is shown in FIG. 2. Sorption pump 26 includes an inner vessel 28 containing a sorbent material 30 therein. Inner vessel 28 is preferably cylindrical in shape and is formed of a highly thermally conductive material, such as copper, although other suitable materials can also be used. Sorbent material 30 contained in inner vessel 28 is formed of a material having a high rate of adsorption at low temperatures. In one embodiment, sorbent material 30 is composed of activated charcoal, which has a high rate of adsorption due to its large total surface area, which is in the range of tens of square meters per gram. It is also envisioned that sorbent material 30 could be composed of a synthetic zeolite material.

A first end 31 of main pumping line 27 is connected to inner vessel 28 and a second end 33 of pumping line 27 is connected to container 20. Main pumping line 27 thus fluidly connects the sorbent material 30 and liquid helium bath 22 (shown in FIG. 1) to allow for adsorption of helium molecules from the bath 22 into the sorbent material 30. The pumping line 27 can extend through the sorbent material 30 as a perforated tube, thus allowing the pumped gas to rapidly equilibrate with sorbent material 30. In one embodiment, this extension through the sorbent material can be centered in inner vessel 28. Inner vessel 28 can also contain heat fins 35 in order to ensure good thermal contact between sorbent material 30 and the wall of inner vessel 28. Similar to inner vessel 28, these heat fins should be made from a material with good thermal conductivity at low temperature.

Surrounding the inner vessel 10 is outer vessel 32. Outer vessel 32 is composed of a thermally conductive material and is thermally connected with a thermally conductive flange 34 (i.e., heat transfer flange) attached thereto. The conductive flange 34 functions to cool the sorption pump 26 to a cryogenic temperature when in sorption mode by thermally connecting the pump to refrigerator 12, as shown in FIG. 1.

Referring back to FIG. 2, outer vessel 32 is separated from inner vessel 28 to form an intermediate gas gap or gas chamber 36 therebetween. The gas chamber 36 is a vacuum sealed chamber into which a gas can be selectively added and removed. A gas line 38 is in fluid communication with the gas chamber 36 to allow for the addition and removal of gas therefrom in a controlled manner. Gas line 38 is connected to a gas source (not shown) containing a supply of thermally conductive gas therein. The addition and removal of gas from the gas chamber 36 allows for the gas chamber 36 to function as either a thermally insulative medium or a thermally conductive medium. That is, when the gas chamber 36 is evacuated of conductive gases therein to form a vacuum, the gas chamber 36 functions to thermally isolate the inner vessel 28, and the sorbent material 30 therein, from the outer vessel 32. Conversely, the addition of a thermally conductive gas to gas chamber 36 by way of gas line 38 forms a thermally conductive medium between the outer vessel 32 and the inner vessel 28 and thus places the sorbent material 30 in thermal contact with the conductive flange 34.

The controlled state of conductivity of the intermediate gas chamber 36 forms a thermal switch that selectively connects the conductive flange 34 and outer vessel 32 to the inner vessel 28 and the sorbent material 30 therein. When a conductive gas fills the gas chamber 36 and forms a conductive medium, the sorbent material 30 is cooled to a cryogenic temperature and the sorption pump 26 operates in a sorption mode. When the gas chamber 36 is evacuated of the conductive gas to form a vacuum, the gas chamber 36 thermally disconnects the conductive flange 34 and outer vessel 32 from the inner vessel 28 and the sorbent material 30 therein. In this state, the sorption pump 26 operates in a desorption mode in which the sorbent material 30 is allowed to raise in temperature to allow for gas molecules adsorbed in the sorbent material 30 to escape (i.e., desorb).

The selective thermal conductivity of the gas chamber 36, and its functioning as a thermal switch to operate sorption pump 26 in sorption and desorption mode, eliminates the need for a separate external thermal switch connected to sorption pump 26. The thermal performance of sorption pump 26 is thus increased by the integration of the “thermal switch” in the form of gas chamber 36.

Referring back to FIG. 1, refrigerator 12 is connected to sorption pump 26 by way of a primary thermal buss 40. Primary thermal buss 40 provides a link between refrigerator 14 and conductive flange 34 to cool sorbent material 30 to a cryogenic temperature to allow sorption pump 26 to operate in sorption mode. The conductive link provided by primary thermal buss 36 is selectively connected and disconnected from sorption pump 26 by way of gas chamber 36, thus allowing for the pump to also exit sorption mode when desired.

After sorption pump 26 has adsorbed a sufficient number of molecules so as to reduce the temperature of liquid helium bath 22 to a desired temperature for hyperpolarization of the sample 16, the sorption pump switches its mode of operation. That is, sorption pump 26 switches to a desorption mode (i.e., reheating/recondensing phase) to allow for the helium molecules adsorbed therein to recondense and transfer back to container 20 to refill the liquid helium bath 22. In desorption mode, the temperature of sorption pump 26 is raised to a temperature such that helium molecules are desorbed from the sorbent material 30 and released therefrom. To achieve this higher temperature, conductive gas is removed from gas chamber 36 to create a vacuum to isolate sorbent material 30 from thermal contact with conductive flange 34 and refrigerator 12. When thermally disconnected from refrigerator 12, sorbent material 30 slowly rises in temperature and enters desorption phase upon reaching a temperature of, for example, 30-40 K.

As mentioned above, helium gas molecules that had previously been vaporized are allowed to recondense in the desorption phase. This recondensing is achieved by way of a helium condenser 42 that is connected to sorption pump 26 by way of pumping line 27. Helium gas released from sorbent material 30 during the desorption phase exits sorption pump 26 by way of the pumping line 27 and is carried to helium condenser 42. Helium condenser 42 functions to cool the helium gas to a temperature necessary to place the helium in a liquid state. Once the helium has been recondensed into a liquid state, it re-enters container 20 and liquid helium bath 22 is refilled. Helium condenser 42 is cooled by refrigerator 12 through connection thereto formed by common thermal buss 44. As shown in FIG. 1, common thermal buss 44 is connected to refrigerator 12 by way of primary thermal buss 40. Common thermal buss 44 then is connected to helium condenser 42 to allow for recondensing of the helium gas that enters into the condenser. As a portion of the liquid helium bath 22 is vaporized and evaporated during the polarization phase, helium condenser 42 serves to reduce helium consumption by allowing sorption pumping system 10 to reuse the liquid helium therein.

Therefore, according to one embodiment of the present invention, a sorption pumping system includes an inner vessel having a sorbent material to adsorb gas molecules therein and an outer vessel positioned about the inner vessel. The sorption pumping system also includes a heat transfer flange connected to the outer vessel and a gas chamber formed between the inner vessel and the outer vessel, the gas chamber being constructed to sealably contain a thermally conductive gas therein.

In accordance with another embodiment of the present invention, an apparatus to lower pressure of a gas in an external system includes a thermally conductive inner vessel, a sorbent material contained in the inner vessel, and an outer vessel surrounding the inner vessel in a separated relation to form a vacuum sealed chamber therebetween. The apparatus also includes a conductive flange thermally connected to the outer vessel, wherein the vacuum sealed chamber is configured to selectively place the sorbent material and the conductive flange in thermal contact.

In accordance with yet another embodiment of the present invention, a method for constructing a sorption pumping system includes the steps of filling a conductive inner vessel with a sorbent material and enclosing the inner vessel with an outer vessel, wherein an intermediate gas gap is formed between the inner vessel and the outer vessel. The method also includes the steps of positioning a conductive flange on the outer vessel, that is thermally connected thereto and fluidly connecting a gas line to the intermediate gas gap to add and remove a conductive gas therefrom to selectively place the conductive flange and the sorbent material in thermal contact with one another.

The present invention has been described in terms of the preferred embodiment, and it is recognized that equivalents, alternatives, and modifications, aside from those expressly stated, are possible and within the scope of the appending claims.

What is claimed is:

1. A sorption pumping system comprising:
an inner vessel having a sorbent material to adsorb gas molecules therein;
an outer vessel positioned about the inner vessel;
a heat transfer flange connected to the outer vessel;
a gas chamber formed between the inner vessel and the outer vessel, the gas chamber constructed to sealably contain a thermally conductive gas therein.

2. The sorption pumping system of claim 1 wherein the gas chamber selectively thermally connects the heat transfer flange to the sorbent material.

3. The sorption pumping system of claim 1 wherein the selective connection between the heat transfer flange and the sorbent material is when in a vacuum state.

4. The sorption pumping system of claim 1 further comprising a gas line fluidly connected to the gas chamber to pump and remove the thermally conductive gas therefrom.

5. The sorption pumping system of claim 1 further comprising a pumping line fluidly having a first end connected to the inner vessel to transfer vaporized gas molecules into and out of the inner vessel.

6. The sorption pumping system of claim 5 further comprising an external chamber connected to a second end of the pumping line and containing a liquid helium bath therein and a substance to be hyperpolarized for use in magnetic resonance (MR) imaging, and wherein the pumping line fluidly connects the inner vessel and the external chamber to transfer vaporized helium gas molecules therebetween.

7. The sorption pumping system of claim 6 further comprising a magnetic field producing device positioned about the external chamber to maintain a selected magnetic field therein.

8. The sorption pumping system of claim 1 further comprising a cooling system connected to the heat transfer flange to cool the sorbent material to a cryogenic temperature.

9. The sorption pumping system of claim 1 wherein the inner vessel is constructed of a highly thermally conductive material.

10. An apparatus to lower pressure of a gas in an external system, the apparatus comprising:
a thermally conductive inner vessel;
a sorbent material contained in the inner vessel;
an outer vessel surrounding the inner vessel in a separated relation to form a vacuum sealed chamber therebetween;
a conductive flange thermally connected to the outer vessel; and
wherein the vacuum sealed chamber is configured to selectively place the sorbent material and the conductive flange in thermal contact.

11. The apparatus of claim 10 further comprising a gas line connected to the vacuum sealed chamber to add and remove a conductive gas.

12. The apparatus of claim 11 wherein the sorbent material and the conductive flange are in thermal contact when the vacuum sealed chamber has the conductive gas therein.

13. The apparatus of claim 11 wherein the sorbent material and the conductive flange are out of thermal contact when the vacuum sealed chamber is in a vacuum state that is devoid of the conductive gas.

14. The apparatus of claim 10 wherein the conductive flange is connected to a closed cycle refrigerator configured to cool the conductive flange to a cryogenic temperature.

15. The apparatus of claim 10 further comprising a pumping line connecting the inner vessel sorbent material to a liquid helium container to transfer vaporized helium gas molecules therebetween.

16. The apparatus of claim 15 wherein the sorbent material adsorbs vaporized helium gas molecules from the liquid helium container when placed in thermal contact with the cooled conductive flange.

17. The apparatus of claim 15 wherein the liquid helium chamber is arranged to receive therein a substance to be hyperpolarized for use in magnetic resonance (MR) imaging.

18. A method for constructing a sorption pumping system comprising the steps of:
filling a conductive inner vessel with a sorbent material;
enclosing the inner vessel with an outer vessel, wherein an intermediate gas gap is formed between the inner vessel and the outer vessel;
positioning a conductive flange on the outer vessel, the conductive flange being thermally connected thereto;
fluidly connecting a gas line to the intermediate gas gap to add and remove a conductive gas therefrom to selectively place the conductive flange and the sorbent material in thermal contact with one another.

19. The method of claim 18 further comprising the steps of:
connecting a first end of a pumping line to an interior volume of the inner vessel;
connecting a second end of the pumping line to an external chamber containing a liquid helium bath therein for use in hyperpolarizing a substance to be used in magnetic resonance (MR) imaging; and
placing the inner vessel in fluid communication with the external chamber via the pumping line to lower a pressure in the external chamber.

20. The method of claim 19 further comprising the step of positioning a superconducting magnet about the external chamber.

21. The method of claim 18 further comprising the step of connecting a cooling system to the conductive flange to cool the sorbent material to a cryogenic temperature when the conductive flange is in thermal contact with the sorbent material.
